(19) United States
(12) Patent Application Publication
(10) Pub. No.: US 2026/0064598 A1
(43) Pub. Date: Mar. 5, 2026

(54) OPTIMIZING USAGE OF THE NAMESPACE LOGICAL-TO-PHYSICAL REFERENCE TABLE IN MEMORY DEVICES

(71) Applicant: Micron Technology, Inc., Boise, ID (US)

(72) Inventor: Hua Ye, San Jose, CA (US)

(21) Appl. No.: 18/818,272

(22) Filed: Aug. 28, 2024

(51) Int. Cl. G06F 12/10

(52) U.S. Cl. CPC G06F 12/10

(57) ABSTRACT

A method includes storing, by a processing device of a memory sub-system controller, on a first memory device, a first address translation metadata structure. An instruction reflecting a namespace change associated with a zoned namespace is received and the first address translation metadata structure is updated based on the instruction. An address translation metadata pointer to reference the first address translation metadata structure during address translation operations associated with the plurality of zoned namespaces is updated and the first address translation metadata structure is copied into a second memory device, thus creating a second address translation metadata structure. The hardware register is updated to point to the second address translation metadata structure during address translation operations associated with the plurality of zoned namespaces.

### TECHNICAL FIELD

Implementations of the disclosure relate generally to memory sub-systems, and more specifically, relate to optimizing usage of the namespace logical-to-physical reference table in memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 illustrates an example computing system that includes a host system and a memory sub-system, in accordance with some implementations of the present disclosure.

FIG. 2 is a detailed block diagram of the computing system of FIG. 1 in accordance with some implementations of the present disclosure.

FIG. 3 illustrates example namespace logical-to-physical metadata maintained in an address translation metadata structure, in accordance with some implementations of the present disclosure.

FIG. 4 is a flow diagram of an example method for updating a primary metadata structure in ZNS systems, in accordance with some implementations of the present disclosure.

FIG. 5 is a block diagram of an example computer system in which implementations of the present disclosure can operate.

### DETAILED DESCRIPTION

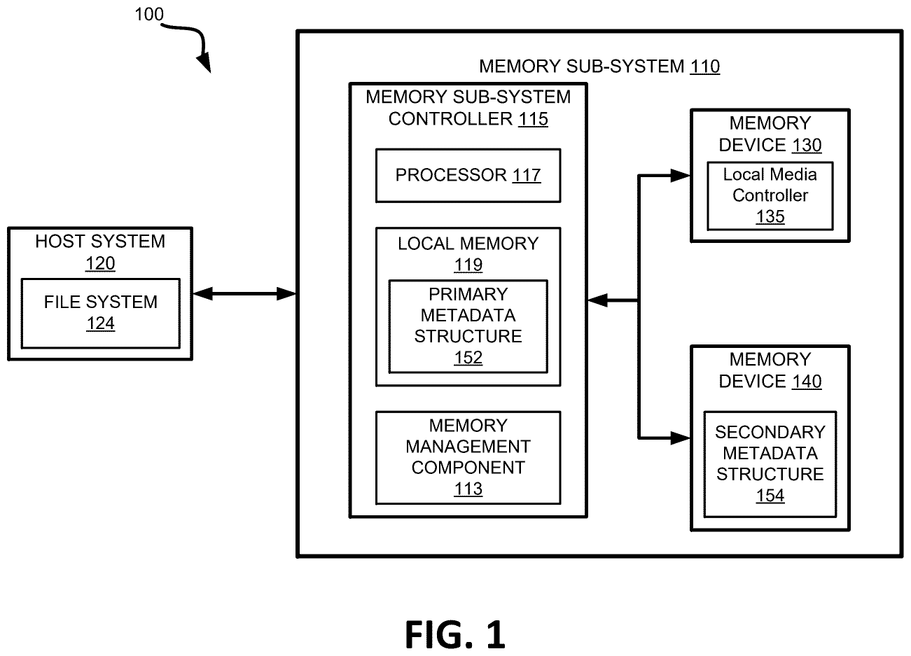

Aspects of the present disclosure are directed to optimizing usage of the namespace logical-to-physical reference table in memory devices. The memory sub-system can be a storage device, a memory module, or a combination of a storage device and memory module. Examples of storage devices and memory modules are described below in conjunction with FIG. 1. In general, a host system can utilize a memory sub-system that includes one or more memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of a non-volatile memory device is a negative-and (NAND) memory device. Other examples of non-volatile memory devices are described in conjunction with FIG. 1. A non-volatile memory device is a package of one or more dies. Each die can include one or more planes. For some types of non-volatile memory devices (e.g., NAND devices), each plane includes a set of physical blocks. Each block consists of a set of pages. Each page includes a set of memory cells (“cells”). A cell is an electronic circuit that store information. Depending on the cell type, a cell can store one or more bits of binary information, and has various logic states that correlate to the number of bits being stored. The logic states can be represented by binary values, such as “0” and “1,” or combinations of such values.

Precisely controlling the amount of the electric charge stored by the memory cell allows establishing multiple logical levels, thus effectively allowing a single memory cell to store multiple bits of information. A read operation can be performed by comparing the measured threshold voltages (Vt) exhibited by the memory cell to one or more reference voltage levels in order to distinguish between two logical levels for single-level cell (SLCs) and between multiple logical levels for multi-level cells. A memory device can include multiple portions, including, e.g., one or more portions where the sub-blocks are configured as SLC memory and one or more portions where the sub-blocks are configured as multi-level cell (MLC) memory that can store three bits of information per cell and/or (triple-level cell) TLC memory that can store three bits of information per cell. The voltage levels of the memory cells in TLC memory form a set of 8 programming (or threshold voltage (Vt)) distributions representing the 8 different combinations of the three bits stored in each memory cell. Depending on how the memory cells are configured, each physical memory page in one of the sub-blocks can include multiple page types. For example, a physical memory page formed from single level cells (SLCs) has a single page type referred to as a lower logical page (LP). Multi-level cell (MLC) physical page types can include LPs and upper logical pages (UPs) and store two bits of information per cell. Further, TLC physical page types can include LPs, UPs, and extra logical pages (XPs) and store three bits of information per cell. Further, quad-level (QLC) physical page types can include LPs, UPS, XPs and top logical pages (TPs) and store four bits of information per cell. For example, a physical memory page formed from memory cells of the QLC memory type have a total of four logical pages, where each logical page stores data distinct from the data stored in the other logical pages associated with that physical memory page, herein referred to as a “page.” MLC memory, TLC memory, QLC memory and PLC memory can be referred to as higher-level cell (HLC) memory.

In some implementations, a file system can group data by locality (e.g., according to thread, process, or application) and write the data sequentially to storage devices. The file system can then write data to different localities as parallel streams to storage devices, each stream being associated with its own locality. Locality can reference either temporal locality or spatial locality. Data having temporal locality is data that a processor tends to access repetitively over a short period of time, e.g., data written, over-written, and trimmed around the same time. Data having spatial locality reflects when a memory device references a particular storage location at a particular time, then the memory device is likely to reference nearby memory locations in the near future. Reference to sequential locality is a special case of spatial locality that occurs when data elements are arranged and accessed linearly, such as in traversing the elements in a one-dimensional array.

A “zone” can be a contiguous (or non-contiguous) portion of a memory device (e.g., range of blocks) that is identified and managed as a single unit. Each zone can have a corresponding zone identification data (a zone identifier, a zone descriptor, a zone label, etc.) that can be used to uniquely identify the zone. Zones can be a fixed size in which all of the zones can be the same size or can be a variable size in which the zones can have different sizes. A zoned namespace (ZNS) can be a sequential namespace defined by a specification and divided into a set of equally-sized zones, which are contiguous non-overlapping ranges of logical block addresses. The host system is aware of the zones supported by the memory sub-system and can allocate data to the zones based on the localities shared by the data. The host system can specify, in a write command, the desired zone to program data to.

A logical address is a virtual address that is used by the host system as a reference to access a data unit corresponding to a physical location (identified by a physical address) on the memory device. The data unit can correspond to a block, a page, or any other granularity. In some systems, the memory sub-system can maintain a namespace logical-to-physical reference table to process memory access commands (e.g., write command, read commands, etc.) received from the host system. This namespace reference table typically includes a set of records where each record can be a mapping between a namespace identifier and logical block address pair, and a respective physical block address.

The namespace reference table can be stored in the local memory (e.g., on-chip memory or static random-access memory (SRAM)) of the memory sub-system controller. This allows the memory sub-system to quickly access the table when translating memory access commands received from the host system. The host system can create new namespaces, modify or reorder existing namespaces, delete obsolete namespaces, and so forth. To perform these changes, the host system can send, to the memory sub-system, an update instruction that indicates the changes to one or more namespaces (e.g., delete a namespace, modify a namespace, create a namespace, etc.). While updating the namespace reference table, the memory sub-system controller can pause all input/output (I/O) operations between the host system and the memory sub-system, and restore the I/O operations once the namespace reference table is updated. However, pausing the I/O operations can cause noticeable latency issues, such as, for example, glitches during a video stream.

A system can use multiple namespace reference tables to avoid pausing the I/O operations. Accordingly, the system can store two copies of the namespace reference table on the local memory of the memory sub-system controller, and direct the memory sub-system controller to one of the tables for address translations (referred to as the active reference table). When the update instructions are received, the memory sub-system controller can update the inactive reference table and switch to using the updated inactive reference table for address translations. However, the storage capacity of the memory sub-system controller's local memory is limited and expensive. As such, storing multiple copies of the namespace reference table in the local memory can cause performance issues in the memory sub-system.

Aspects of the present disclosure address the above and other deficiencies by optimizing usage of the address translation metadata structures in memory devices. In particular, the memory sub-system controller can maintain two namespace logical-to-physical metadata structures (e.g., reference tables, indexed linear arrays), referred to as a primary metadata structure and a secondary metadata structure. The primary metadata structure can be stored on the local memory (e.g., SRAM) of the memory sub-system controller while the secondary metadata structure can be stored on, for example, volatile memory (e.g., dynamic random-access memory (DRAM)) coupled to the memory sub-system controller. During regular operations, the memory sub-system controller can reference the primary metadata structure for namespace address translations. To request a change to one or more namespaces (e.g., delete a namespace, modify a namespace, create a namespace), the host system can send, to the memory sub-system, an update instruction. The change request can be due to, for example, the host system executing a new application (thus requesting a new namespace(s) for the application) or closing an existing application (thus requesting the deletion of a namespace(s) which would free physical blocks for other use). In response to receiving the update instruction from the host system, the memory sub-system controller can update the secondary metadata structure to add one or more new namespaces, remove one or more namespace, or modify one or more existing namespace. During the update, memory sub-system controller can assign and map corresponding physical block addresses to the logical block addresses of the added or modified namespace(s) referenced in the update instruction, or, in the case of a deleted namespace, release the corresponding physical blocks into a free pool of blocks. The memory sub-system controller can then switch to using the secondary metadata structure for address translations while the memory sub-system controller updates the primary metadata structure with the new mappings referenced in the update instruction. The update can be performed by, for example, updating the records of the primary metadata structure, copying the secondary metadata structure into the local memory, etc. The switch can be performed by, for example, updating the address used to reference the namespace metadata structure (e.g., update the address from the location of the primary metadata structure to the address of the secondary metadata structure). Once the primary metadata structure is updated, the memory sub-system controller can switch back to reference the primary metadata structure for address translations. Since the I/O operations are not paused during the update, noticeable latency issues are avoided. Further, since only one namespace metadata structure is stored on the controller's local memory, certain performance issues stemming from an overburdened local memory are avoided.

Routinely, the memory sub-system controller can perform memory maintenance operations such as, for example, refreshing stored data by moving data from one physical block to another physical block. During these maintenance operations, the memory sub-system controller can update the records of the primary metadata structure to reference the changes to the address mappings. To keep the secondary metadata structure current, in some implementations, the memory sub-system controller can update the secondary metadata structure to reference these changes as well. In other implementations, the memory sub-system controller can copy the updated primary metadata structure into the volatile memory after one or more maintenance operations are performed, or in response to receiving an update instruction from the host system.

Advantages of the present disclosure include, but are not limited to, an improved performance of the memory sub-system by decreasing the resources used by a controller's local memory for performing namespace address translations. Further advantages include a reduction in latency and memory overhead from utilizing excess memory for storing namespace metadata structures. This can result in an improvement of performance and speed of the memory sub-system, a reduction of memory consumption, and a decrease in power consumption by the memory sub-system. Although implementations are described using namespace metadata structures such as reference tables, aspects of the present disclosure can be applied to other types metadata structures, such as, for example, indexed linear arrays (e.g., linear arrays indexed by logical block addresses, linear arrays indexed by physical block addresses, etc.) or any other structured format for storing relational data.

FIG. 1 illustrates an example computing system 100 that includes a memory sub-system 110 and a host system 120 in accordance with some implementations of the present disclosure. The memory sub-system 110 can include media, such as one or more non-volatile memory devices (e.g., memory device 130), one or more volatile memory devices (e.g., memory device 140), or a combination of such. Each memory device 130 or 140 can be one or more memory component(s).

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some implementations, the host system 120 is coupled to different types of memory sub-system 110. FIG. 1 illustrates one example of a host system 120 coupled to one memory sub-system 110. As used herein, “coupled to” or “coupled with” generally refers to a connection between components or devices, which can be an indirect communicative connection or direct communicative connection (e.g., without intervening components or devices), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface, which can communicate over a system bus. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some implementations, each of the memory devices 130 can include one or more arrays of memory cells such as SLCs, MLCs, TLCs, QLCS, PLCs or any combination of such. In some implementations, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some implementations, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another implementation of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands from the host system 120 and can convert the commands into appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some implementations, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some implementations, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some implementations, memory sub-system 110 is a managed memory device, which is a raw memory device 130 having control logic (e.g., local media controller 135) on the die and a controller (e.g., memory sub-system controller 115) for memory management within the same memory device package. An example of a managed memory device is a managed NAND (MNAND) device.

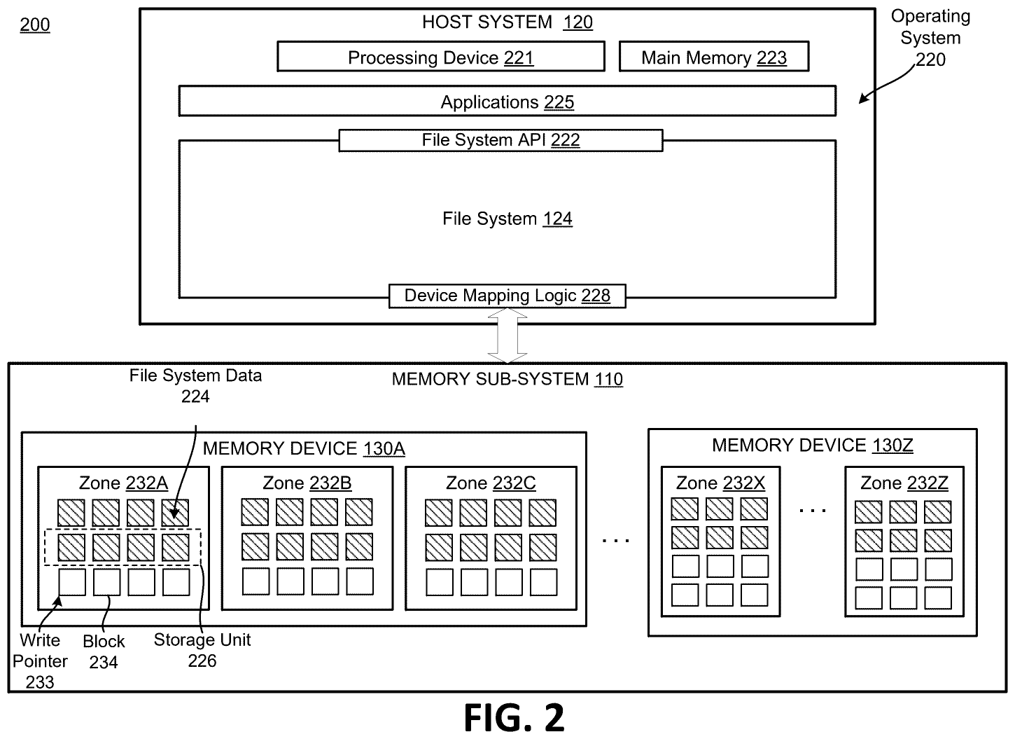

The memory sub-system 110 includes a memory management component 113 that can be used to manage namespace logical-to-physical address translation metadata structures (i.e., primary metadata structure 152 and secondary metadata structure 154) in accordance with implementations of the present disclosure. A namespace is a segment of memory that can be split into multiple management units (e.g., logical or physical blocks), and will be discussed in detail in FIG. 2. Each of primary metadata structure 152 and secondary metadata structure 154 can be a reference table, indexed linear array, or any other structured format used to organize, track, and/or store relational address data in a particular format. Each of primary metadata structure 152 and secondary metadata structure 154 can store a set of records, where each record can include a mapping of a logical block address of host system 120 to a physical block address of memory device 130, 140. While implementations herein refer to logical block addresses and physical block addresses, it is noted that implementations of this disclosure can be used with logical addresses and physical addresses that reference any size memory granularity.

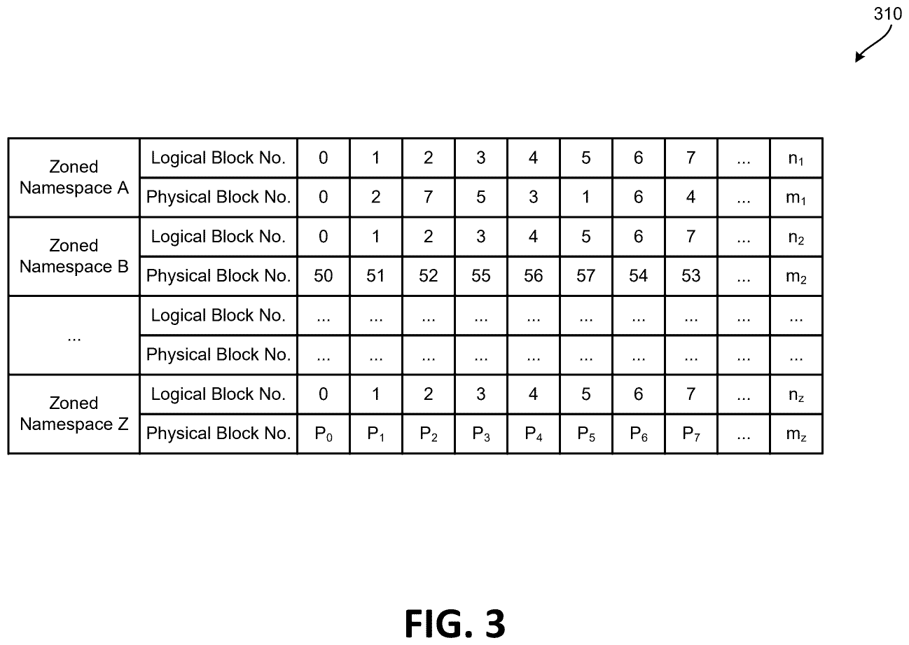

FIG. 3 schematically illustrates example namespace logical-to-physical metadata maintained in an address translation metadata structure, in accordance with some implementations of the present disclosure. In particular, FIG. 3 shows namespace reference table 310, which can be primary metadata structure 152 and/or secondary metadata structure 154. As shown in namespace reference table 310, each (zoned) namespace (e.g., zoned namespace A) can include an array of logical blocks (e.g., logical block 0, 1, 2, . . . , n₁) each mapped to a corresponding physical block (e.g., physical block 0, 2, 7, . . . , m₁). In some implementations, memory sub-system controller 115 can receive, from host system 120, a two-dimensional tuple (an ordered sequence of values) that references a namespace identifier (“NSID”) and a logical block address (“LBA”). Memory sub-system controller 115 can then translate, using namespace reference table 310, the two-tuple (e.g., <NSID, LBA>) into a one dimensional translation unit (e.g., the physical block value).

Returning to FIG. 1, memory sub-system controller 115 can reference primary metadata structure 152 for address translations in response to memory access commands (e.g., read commands, write commands, erase commands, etc.). For example, in response to receiving, from host system 120, a read access command referencing a particular logical block address, memory sub-system controller 115 can perform a look-up of the logical block address in primary metadata structure 152, determine the corresponding physical block address, and retrieve data from the corresponding physical block. In some implementations, primary metadata structure 152 can be stored on local memory 119. By being stored on local memory 119 (e.g., a controller cache, on-chip memory, SRAM memory, etc.), the hardware and/or firmware of memory sub-system controller 115 can access and/or retrieve data from primary metadata structure 152 with increased speed (e.g., as compared with accessing data from memory device 130, 140).

Secondary metadata structure 154 can be stored on memory device 140. Secondary metadata structure 154 can store the mappings of primary metadata structure 152. In response to the memory sub-system controller 115 receiving an update instruction from host system 120, memory management component 113 can update secondary metadata structure 154 using the data in the update instruction. An update instruction can include one or more namespace identifiers (NSID) and a request to perform an action such as, for example, create a new namespace, delete an existing namespace, modify an existing namespace (e.g., add or remove one or more logical block from the namespace), etc. In instances of adding a new namespace or modifying an existing namespace, the update instruction can further include a set of logical block addresses. When updating secondary metadata structure 154, memory management component 113 can assign a physical block (via a physical block address) to each respective logical block address listed in the update instruction. Once the update is complete (one or more namespaces are added, modified, or deleted, one or more new mappings are added, one or more current mappings are deleted, one or more current mappings are modified, etc.), memory management component 113 can instruct the memory sub-system controller 115 to switch to secondary metadata structure 154 for processing subsequent memory access commands (e.g., use secondary metadata structure 154 instead of primary metadata structure 152).

To perform the switch, memory management component 113 can, for example, update an address translation metadata pointer by, for example, changing the address used by memory sub-system controller 115 to access primary metadata structure 152 to the address of the of secondary metadata structure 154. In some implementations, the address can be stored in a specific hardware register of memory management component 113. Memory management component 113 can then update primary table 152 using the data in the update instruction (thus, primary metadata structure 152 and secondary metadata structure 154 will each include the same mappings). Memory management component 113 can then instruct memory sub-system controller 115 to switch back to primary table 152 for processing memory access commands (e.g., use primary metadata structure 154 instead of secondary metadata structure 152). Switching back can include memory management component 113 update the address translation metadata pointer by, for example, changing the address used by memory sub-system controller 115 to access secondary metadata structure 154 to the address of the of primary metadata structure 152.

In some implementations, memory management component 113 can perform memory maintenance operations. Memory maintenance operations can include, for example, refreshing stored data, wear leveling, retiring bad block, etc. During these maintenance operations, memory management component 113 can update the records of primary metadata structure 152 to reference the changes to the address mappings. To keep secondary metadata structure 154 current, in some implementations, memory management component 113 can update the secondary metadata structure to reference these changes. In other implementations, memory management component 113 can copy the updated primary metadata structure 152 into memory device 140 (thus generating an updated secondary metadata structure 154) after one or more maintenance operations are performed, or in response to receiving an update instruction from host system 120.

FIG. 2 is a detailed block diagram of the computing system 200 that includes a file system that uses the multiple zones of a memory sub-system to more efficiently store data. In the example shown, host system 120 includes a file system 124, one or more applications 225 and the memory sub-system 110 includes multiple zones 232A-Z that are spread across one or more memory devices 130A-Z.

File system 124 can manage the storage and retrieval of data from the memory sub-system 110. File system 124 can utilize data structures and rules used to organize the data, which can involve separating the data into storage units that that can be individually identified and accessed. File system 124 can be integrated into a kernel, a device driver, an application, other portion of operating system 220, or a combination thereof. File system 124 can execute as one or more system processes (e.g., kernel processes), user processes (e.g., application processes), or a combination thereof.

File system 124 can include multiple layers and the multiple layers can include a logical file system (e.g., logical layer), a virtual file system (e.g., virtual layer), a physical file system (e.g., physical layer), or other layer. The logical file system can manage interaction with applications 225 and can provide an application program interface (e.g., File System API 222) that exposes file system operations (e.g., open, close, create, delete, read, write, execute) to other computer programs. The logical layer of file system 124 can manage security and permissions and maintain open file table entries and per-process file descriptors. The logical file system can pass requested operations (e.g., write requests) to one or more other layers for processing. The virtual file system can enable operating system 220 to support multiple concurrent instances of physical file systems, each of which can be referred to as a file system implementation. The physical file system can manage the physical operation of the storage device (e.g. memory sub-system 110). The physical file system can handle buffering and manage main memory and can be responsible for the physical placement of storage units in specific locations on the memory devices 130A-Z. The physical file system can include device mapping logic 228 and can interact with device drivers or with the channel to interact with memory sub-system 110. One or more of the file system layers can be explicitly separated or can be combined together in order to store file system data 224.

File system data 224 can be any data associated with file system 124 and can include data received by file system 124 or data generated by file system 124. File system data 224 can represent data of one or more external file system objects, internal file system objects, or a combination thereof. The external file system objects can be file system objects that are externally accessible by a computer program (e.g., applications 225) using file system API 222. The external file system objects can include files (e.g., file data and metadata), directories (e.g., folders), links (e.g., soft links, hard links), or other objects. The internal file system objects can be file system objects that remain internal to the file system and are inaccessible using file system API 222. The internal file system objects can include storage tree objects (e.g., extent map, extent tree, block tree), stream objects (e.g., stream identifiers), file group data (e.g., group of similar files), storage units, block groups, extents, or other internal data structures.

Each file system object can include object data and can be associated with object metadata. The object data can be the content of the object (e.g., file data) and the object metadata can be information about the object (e.g., file metadata). The object metadata can indicate attributes of the object such as a storage location (e.g., zone, block group, storage unit), data source (e.g., stream, application, user), data type (e.g., text, image, audio, video), size (e.g., file size, directory size), time (e.g., creation time, modification time, access time), ownership (e.g., user ID, group ID), permissions (e.g., read, write, execute), file system location (e.g., parent directory, absolute path, local path), other attribute, or a combination thereof. In one example, file system data 224 can include data for a new file and the new file can include file data and file metadata. The file data can include the content of the file (e.g., image content, audio content) and the file metadata can include one or more attributes of the content (e.g., identifier corresponding to a zone z, stream s, and/or application a).

The object data and object metadata (e.g., attributes, tree nodes) can be stored together in the same data structure at the same storage location or can be stored separately in different data structures at different storage locations. For example, file system 124 can store the object metadata in an index node (“inode”) data structure and the index node data structure can have one or more pointers to the object data. The inode can be a data structure in a Unix-style file system that describes a file system object. Each inode can indicate the attributes and storage locations (e.g., block addresses) of the data of the file system object. A directory can be represented by an inode and can contain an entry for itself, its parent (e.g., parent directory), and each of its children (e.g., child directories or files). File system 124 can store file system data 224 as one or more storage units 226.

Storage unit 226 can be a contiguous or non-contiguous portion of file system data that is to be stored in a memory device. The storage units can be referred to as file system storage units and can have any size (e.g., 4 KB, 128 KB, 16 MB, 128 MB, 1 GB) and the size can or cannot be based on (e.g. a multiple of) the size of one or more memory storage units (e.g., cells, blocks, pages, zones, dies, devices, or sub-systems). File system 124 can use a fixed size (e.g., constant size or static size) for the storage units in which all of the storage units can be the same size or can use a variable size (e.g., adjustable size, dynamic size) in which the storage units used by file system 124 can have different sizes. The size of the storage unit can be determined (e.g., selected or detected) by file system 124, host system 120, memory sub-system 110, memory device 130, other entity, or a combination thereof. The size of storage unit 226 can be determined by the entity before, during, or after design, development, manufacture, installation, initialization, configuration, formatting, other event, or a combination thereof. In one example, each of the storage units 226 can be the same or similar to a file system block group.

File system 124 can divide allocated space into block groups which can be variable-sized allocation regions. The allocation regions can be used to store object metadata (e.g., extent tree node, inodes) and object data (e.g., file content, extents). A block group (BG) can be understood as a contiguous portion a file system object (e.g., a series of LBAs) that is allocated to a contiguous area of a memory device and is reserved for file system data of file system 124. This contiguous area can be represented as a range of block numbers (e.g., logical addresses).

Memory sub-system 110 can include high density non-volatile memory devices where retention of data is desired when no power is supplied to the memory device. One example of non-volatile memory devices is a negative-and (NAND) memory device. Other examples of non-volatile memory devices are described above in conjunction with memory device 130 of FIG. 1. A non-volatile memory device is a package of one or more dies with sets of blocks (e.g., physical blocks) and each block can include a set of pages. A page can include a set of memory cells and each cell can be an electronic circuit that stores information. Depending on the cell type, a cell can store one or more bits of binary information and can have various logic states that correlate to the number of bits being stored. The logic states can be represented by binary values, such as “0” and “1”, or combinations of such values.

Each memory devices 130A-Z can include one or more arrays of memory cells arranged in a two-dimensional grid. Memory cells are typically joined by wordlines (conducting lines electrically connected to the cells' control gates) and programmed together as memory pages (e.g., 16 KB or 32 KB pages) in one setting (by selecting consecutive bitlines connected to the cells' source and drain electrodes). The intersection of a bitline and wordline can constitute the address of the memory cell. A block 234 can refer to a unit of the memory device (e.g., 130A) used to store data and can include a group of memory cells, a wordline group, a wordline, or individual memory cells. One or more blocks can be grouped together to form a zone of a memory device.

Each of the zones 232A-Z can be a contiguous or non-contiguous portion of a memory device (e.g., range of blocks) that is identified and managed as a single unit. Each zone can have a corresponding zone identification data that can be used to uniquely identify the zone and can include a zone identifier (zone ID), a zone descriptor, or a zone label. Memory sub-system 110 can use a fixed size (e.g., constant size or static size) for the zones in which all of the zones can be the same size or can use a variable size (e.g., adjustable size, dynamic size) in which the zones used by memory sub-system 110 can have different sizes. The size of the zone can be determined by memory sub-system 110, memory device 130, file system 124, host system 120, other entity, or a combination thereof.

Zones 232A-Z can enable efficient management of storage space of the memory device. For example, a set of one or more zones can be designated for use by a specific application (e.g., application, process, or thread) executed by the host system or some other system with access to the memory device. Writing to the zones is generally performed sequentially. The sequential write can be performed consecutively from the top of the memory device (e.g., smaller addresses of IC die) to the bottom of the memory device (e.g., larger addresses of the IC die), which is illustrated by the patterned blocks of data already written to the illustrated zones 232A-Z. In these implementations, the device mapping logic 228 can track block numbers (e.g., logical block addresses) of a namespace. Device mapping logic 228 (or any other component of file system 124) can generate an update instruction to alert memory sub-system 110 to any namespace changes, such as a new namespace, a modified or reordered namespace, a delete namespace, and so forth.

The namespace can be referenced by the address space of one or more of the memory devices 130A-Z. A namespace is a segment of memory that can be split into multiple management units (e.g., logical or physical blocks). A controller for memory devices 130A-Z (e.g., controller 115 or 135) can support multiple namespaces that are referenced using namespace identification data (e.g., namespace IDs). A namespace can be associated with a namespace data structure that is created, updated, or deleted using Namespace Management and Namespace Attachment commands. The namespace data structure can indicate capabilities and settings that are specific to a particular namespace. In one example, the name data structure and the namespace can correspond to a zoned namespace.

A zoned namespace (ZNS™) can be a sequential namespace that is defined by the NVM Express™ (NVMe™) Specification. A memory device that is configured with a zone namespace can be referred to as a zoned namespace memory device or a ZNS memory device and can implement the Zoned Namespace Command Set as defined by NVMe. In a zone namespace, the address space of each of the memory devices 130A-Z can be divided into one or more zones 232A-Z. When using a zone namespace, writes are performed sequentially starting from the beginning of a zone and can be performed at a different granularities (e.g., 64 kilobytes, 128 kilobytes, etc.). In one example, the zoned namespace can be implemented by a controller of a solid state drive (SSD) and include zones 232A-Z, in which there can be one or more zones for each of the one or more memory devices 130A-Z.

A write pointer (WP) identifies a location in the zone where a prior sequential write ended. A WP can be maintained for each of zones 232A-Z. The write pointer 233 can correspond to zone 232A and can point to the beginning of a block (e.g., first available block), the end of a block (e.g., last block written to), a location within a block. Write pointer 233, which can be stored in a metadata area of memory device 130A-Z, can be maintained by the controller of memory device 130A (e.g., controller 135), a controller of memory sub-system 110 (e.g., controller 115), and/or processing device 221 of host system 120 (e.g., in main memory 223).

File system 124 can maintain a file system API 222 that enables computer programs (e.g., applications 225) to store or retrieve data. File system API 222 can enable file system 124 to receive data from external sources, including data from applications 225 (also referred to as user data), operating system (e.g., superblocks of data, file system metadata, and the like). With access to such metadata about these various files of different data types, the file system API 222 can be able to enable file system 124 to perform organization and storage allocation.

The applications 225 can include different types of computer programs or architectures, which function differently with respect hardware and supporting software of the computing system 100. Each of the applications 225 can thus generate, access, and/or manage files of one or more data types.

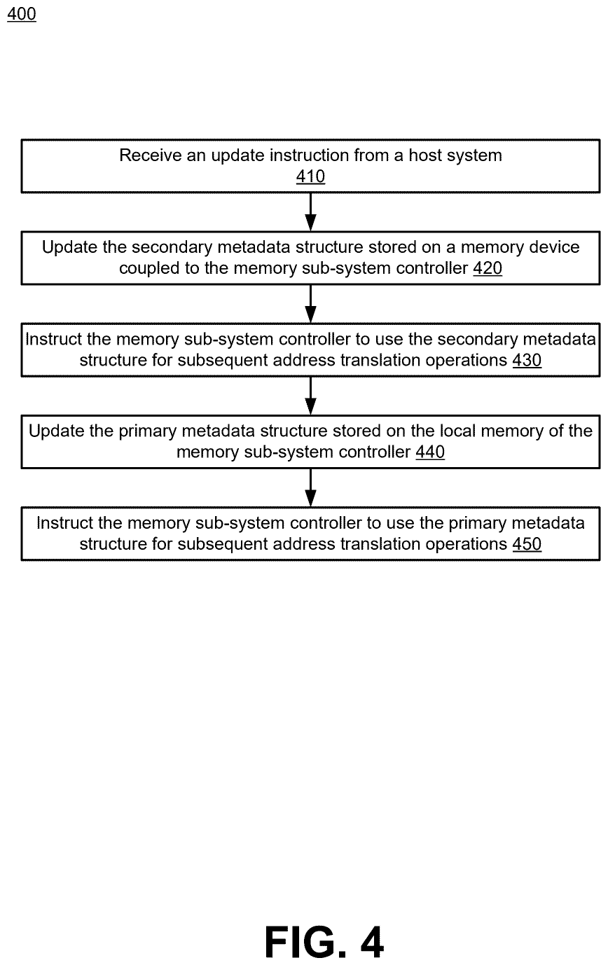

FIG. 4 is a flow diagram of an example method 400 for updating a primary metadata structure in ZNS systems, in accordance with some implementations of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, the method 400 is performed by the memory sub-system controller 115 (e.g., by memory management component 113) of FIG. 1. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 410, processing logic receives an update instruction from a host system. The update instruction can be initiated by a host (e.g., host 120) or by a memory sub-system controller (e.g., memory sub-system controller 115). The update instruction can reference one or more logical memory address related to one or more namespaces. In some implementations, the instruction references at least one of a new namespace, a modification to an existing namespace, or a deletion of an obsolete namespace.

At operation 420, processing logic updates, using data in the update instruction, the secondary metadata structure stored on a memory device coupled to the memory sub-system controller. The memory device can include memory device 140 and/or memory device 130.

At operation 430, processing logic instructs the memory sub-system controller to use the secondary metadata structure for subsequent address translation operations (e.g., switch from using the primary metadata structure to using the secondary metadata structure). Instructing the memory sub-system controller to use the secondary metadata structure can include replacing the address referencing the location of the primary metadata structure with the address referencing the location of the secondary metadata structure. The address can be stored in a dedicated hardware register of the memory sub-system controller.

At operation 440, processing logic updates, based on the instruction, the primary metadata structure stored on the local memory of the memory sub-system controller.

At operation 450, processing logic instructs the memory sub-system controller to use the primary metadata structure for subsequent address translation operations (e.g., switch from using the secondary metadata structure to using the primary metadata structure). Instructing the memory sub-system controller to use the primary metadata structure can include replacing the address referencing the location of the secondary metadata structure with the address referencing the location of the primary metadata structure.

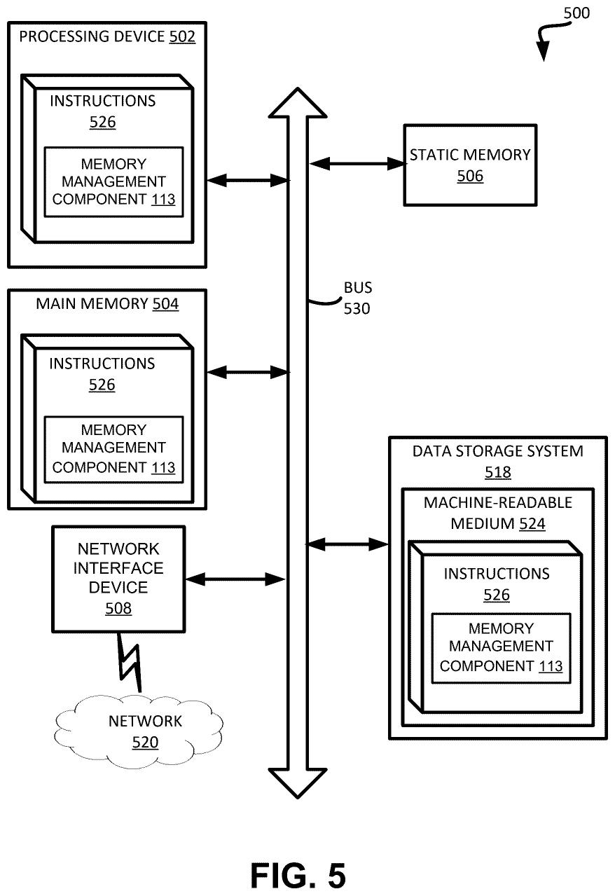

FIG. 5 illustrates an example machine of a computer system 500 within which a set of instructions, for causing the machine to perform any one or more of the methodologies discussed herein, can be executed. In some implementations, the computer system 500 can correspond to a host system (e.g., the host system 120 of FIGS. 1-2) that includes, is coupled to, or utilizes a memory sub-system (e.g., memory sub-system 110 of FIG. 1) or can be used to perform the operations of a controller (e.g., to execute an operating system to perform operations corresponding to the memory management component 113 of FIG. 1). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a non-transitory computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one implementation, the instructions 526 include instructions to implement functionality corresponding to media management component 113 of FIG. 1. While the machine-readable storage medium 524 is shown in an example implementation to be a single medium, the term “non-transitory machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., non-transitory computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A method comprising:
storing, by a processing device of a memory sub-system controller, on a first memory device, a first address translation metadata structure;
receiving an instruction reflecting a namespace change associated with a zoned namespace;
updating the first address translation metadata structure based on the instruction;
updating an address translation metadata pointer to reference the first address translation metadata structure during address translation operations associated with the plurality of zoned namespaces;
copying the first address translation metadata structure into a second memory device thus creating a second address translation metadata structure; and
updating the hardware register to point to the second address translation metadata structure during address translation operations associated with the plurality of zoned namespaces.

2. The method of claim 1, wherein the first memory device comprises a volatile memory device.

3. The method of claim 1, wherein the second memory device comprises a non-volatile memory device.

4. The method of claim 1, wherein the instruction references at least one of a new namespace, a modification to an existing namespace, or a deletion of an obsolete namespace.

5. The method of claim 1, wherein the first address translation metadata structure references a set of physical blocks from a third memory device.

6. The method of claim 1, wherein the first address translation metadata structure references a combination of a namespace identifier and a logical block address mapped to a physical block address.

7. The method of claim 1, wherein updating the address translation metadata pointer comprises storing an address referencing the first address translation metadata structure in a particular hardware register.

8. A system comprising:
a first memory device; and
a processing device, operatively coupled with the memory device, to perform operations comprising:
storing, on a first memory device, a first address translation metadata structure;
receiving an instruction reflecting a namespace change associated with a zoned namespace;
updating the first address translation metadata structure based on the instruction;
updating an address translation metadata pointer to reference the first address translation metadata structure during address translation operations associated with the plurality of zoned namespaces;
copying the first address translation metadata structure into a second memory device thus creating a second address translation metadata structure; and
updating the hardware register to point to the second address translation metadata structure during address translation operations associated with the plurality of zoned namespaces.

9. The system of claim 8, wherein the first memory device comprises a volatile memory device.

10. The system of claim 8, wherein the second memory device comprises a non-volatile memory device.

11. The system of claim 8, wherein the instruction references at least one of a new namespace, a modification to an existing namespace, or a deletion of an obsolete namespace.

12. The system of claim 11, wherein the first address translation metadata structure references a set of physical blocks from a third memory device.

13. The system of claim 8, wherein the first address translation metadata structure references a combination of a namespace identifier and a logical block address mapped to a physical block address.

14. The system of claim 8, wherein updating the address translation metadata pointer comprises storing an address referencing the first address translation metadata structure in a particular hardware register.

15. A non-transitory computer-readable medium storing instructions, which when executed by a processing device, cause the processing device to perform operations comprising:
storing, on a first memory device, a first address translation metadata structure;
receiving an instruction reflecting a namespace change associated with a zoned namespace;
updating the first address translation metadata structure based on the instruction;
updating an address translation metadata pointer to reference the first address translation metadata structure during address translation operations associated with the plurality of zoned namespaces;
copying the first address translation metadata structure into a second memory device thus creating a second address translation metadata structure; and
updating the hardware register to point to the second address translation metadata structure during address translation operations associated with the plurality of zoned namespaces.

16. The non-transitory computer-readable medium of claim 15, wherein the first memory device comprises a volatile memory device.

17. The non-transitory computer-readable medium of claim 15, wherein the second memory device comprises a non-volatile memory device.

18. The non-transitory computer-readable medium of claim 15, wherein the instruction references at least one of a new namespace, a modification to an existing namespace, or a deletion of an obsolete namespace.

19. The non-transitory computer-readable medium of claim 15, wherein the first address translation metadata structure references a set of physical blocks from a third memory device.

20. The non-transitory computer-readable medium of claim 15, wherein the first address translation metadata structure references a combination of a namespace identifier and a logical block address mapped to a physical block address.
